(19) United States
(12) Patent Application Publication
(10) Pub. No.: US 2013/0170565 A1
(43) Pub. Date: Jul. 4, 2013

(54) Motion Estimation Complexity Reduction

(71) Applicant: Faramarz Azadegan, La Jolla, CA (US)

(72) Inventor: Faramarz Azadegan, La Jolla, CA (US)

(21) Appl. No.: 13/341,568

(22) Filed: Dec. 30, 2011

(51) Int. Cl. H04N 7/26

(52) U.S. Cl. 375/240.27; 375/E07.119

(57) ABSTRACT

A process for reducing computational complexity associated with motion estimation and thereby reducing the power consumption and reducing cycle requirements for video compression techniques is described. A process for improving motion estimation based on only comparing a fraction of total pixels involved in the block matching of a target block and the search area and the best match so far found for the target block. The processes involve improvements to MPEG-1, H.261, MPEG-2/H.262, MPEG-4, H.263, H.264/AVC, VP8, and VC-1 video coding standards and any other video compression technique employing a motion estimation technique.

### BACKGROUND OF THE INVENTION

1. Field of the Invention

The present invention relates generally to motion estimation in the field of video compression and pattern matching systems. This invention may be used for integration into digital signal processing (DSP) systems, application specific integrated systems (ASIC) and system on chip (SOC) and further to general software implementation. More particularly, the invention relates to methods for reducing the computational complexity associated with finding the best match for a particular block or area in the motion estimation process. Motion estimation is an integral part of any video compression system, and pattern matching technique is an integral part of any video or image search system.

2. Description of the Related Art

The electronic transmission of video pictures, either analog or digital, has presented various problems of both transmission or storage quality, transmission or storage efficiency, transmission bandwidth or storage size in the art of video communication. In the context of digital video transmissions particularly, quality and, bandwidth or storage, and efficiency issues are frequently intertwined. Over the years, the most common solution to these issues has involved various types of video compression.

There are two components to video compression, spatial compression and temporal compression. Spatial compression strives to achieve a reduction in the information content of the video transmission by applying mathematical methods to reduce the redundancy of the contents of one video frame using the information only contained in that frame, thus, to reduce spatial redundancy. One of the most common mathematical methods for reducing spatial redundancy is discrete cosine transform (DCT), as used by the Joint Picture Experts Group (JPEG) standard for compression of still images. In addition, video signals, are frequently compressed by DCT or other block transform or filtering techniques, such as wavelet, to reduce spatial redundancy pursuant to the Motion-JPEG (M-JPEG) or JPEG-2000 standards.

In addition to spatial compression, temporal compression is used for video signals since video sequences have highly correlated consecutive frames which are exploited in temporal compression schemes. Video compression techniques frequently apply temporal compression for purposes of video compression, pursuant to the Motion Picture Experts Group (MPEG) standards. One of the fundamental elements of temporal compression involves the reduction of data rates, and a common method for reducing data rates in temporal compression is motion estimation in the encoder (transmitter) and motion compensation in the decoder (receiver). Motion estimation is a method of predicting one frame based upon an earlier transmitted frame. For example, in motion estimation, a predicted frame (P-frame) or bi-directionally predicted frame (B-frame) is compressed based on an earlier transmitted intra-coded frame (I-frame, that is, a frame that has only been only spatially coded) or an earlier transmitted predicted frame (P-frame, that is, a predicted frame that has been coded and transmitted). In this manner, using temporal compression, the P-frame or B-frame is coded based on the earlier I-frame or earlier P-frame. Thus, if there is little difference between the P-frame/B-frame and the previous I-frame/P-frame, motion estimation and motion compensation will result in a significant reduction of the data needed to represent the content of the video using temporal compression.

Various standards have been proposed for using both spatial and temporal compression for the purposes of video compression. The International Telecommunication Union (ITU), for example, has established the H.261, H.262, H.263, and H.264/AVC standards for the transmission of video for variety of networks. Similarly International Systems Organization (ISO) has established MPEG-1, MPEG-2, MPEG-4 for transmission or storage of video for variety of applications.

All of these standards focus on both spatial compression and temporal compression with the temporal compression providing major part of the compression. As a result, the attention to temporal compression is much higher than spatial compression.

The coding structure in all standard video compression systems described (MPEG-1, MPEG-2, MPEG-4, H.261, H.262, H.263, H.264) uses macroblocks, MB, for coding structure.

The MB in MPEG (MPEG-1, MPEG-2 MPEG-4) or ITU H.263 or H.264/AVC systems is of size 16×16 of luminance, which means they consist of 16 rows by 16 columns luminance, and the spatially corresponding 8×8 block sizes for two chrominance components U and V for 4:2:0 systems, where 4:2:0 indicates the sampling structure used for luminance and chrominance of signal. For 4:2:2 and 4:4:4 systems which contain higher chrominance resolution corresponding to higher sampling rates for the chrominance signals, the chrominance components are the spatially corresponding sizes of 16×8 and 16×16 respectively. In recent video compression systems such as H.264, this luminance part of macro block may be partitioned into smaller sizes of 4×4, 8×4, 4×8, 8×8, etc. with the appropriate corresponding sub-partitioning of chrominance blocks.

The compression system for said standards follow a strict coding structure in which it compresses MBs sequentially from left to right and top to bottom of each frame, starting at the top-left corner of the frame and ending at the right-bottom corner of the frame. More specifically, after a row of MBs are coded, the next vertically lower adjacent row of the MBs are coded from left to right. The general format of compression of each MB consists of block transform of original data for I-frame or residual/original data for P-frame and B-frame along with motion vectors for the MB of P-frame or B-frame. The motion vectors represent the offset between the target MB, that is the MB to be compressed, and the closest match in the previous frame or frames (for B-frame) which has already been compressed and transmitted. The block transform is followed by quantization and variable-length-coding (VLC) creating a bitstream representation for the MB. The bitstream for MBs are appended based on the said coding structure (left to right and top to bottom of the frame) to create a bitstream representation for the frame. Each of the said resulting bitstreams for the frames is sequentially appended to create the bitstream for the entire video.

The motion estimation technique used to accomplish temporal compression generally uses a so-called block matching algorithm using only the 16×16 luminance of the MB. In the said block matching algorithm, an MB from the current frame to be encoded, called the target MB is selected and a search is conducted within the previously coded frame to find the best match to the said target MB. This procedure is referred to as motion estimation technique. In recent video compression systems such as H.264, this luminance part of macro block may be partitioned into smaller sizes of 4×4, 8×4, 4×8, 8×8, etc. for motion estimation with the appropriate corresponding sub-partitioning of chrominance blocks for the rest of the compression process. In the search mechanism for H.264, any of these smaller size blocks may be used for find the best match in the previous frame to the said block.

In the motion estimation procedure, the search region in the previously transmitted frame is generally centered on the same spatial location as the target MB in the current frame, except possibly for the border MBs. For the border MBs, the borders of the previously coded frame may be extended to accommodate this centering of the MB within the search region. The horizontal portion of search region is extended in both left and right directions. Similarly the vertical portion of the search region is extended in both up and down directions. As an example if the horizontal search is extended by 32 pixels to the left, and 31 pixels to the right, the horizontal search region is denoted by [−32, 31]. Similarly, the vertical portion of the search region might extent in both direction by −16 pixels (16 pixels to the top of the target MB) and +15 pixels (15 pixels to the bottom of MB). This is denoted by [−16, 15]. This is depicted in FIG. 2. The search region might exceed the actual frame boundaries as described, for example, in MPEG-4. Put together, the search region defines a rectangular region defined by the parameters for horizontal and vertical values. For the example the above search region is defined by [−32, 31]×[×16, 15]. The search region is carefully chosen to match the computational capability of the encoder along with the required power consumption while matching the type of video content.

The criterion used to find the best match is generally sum of absolute difference (SAD) values of target MB and the search area candidate in previously coded frame of size MB. More specifically, the sum of absolute pixel by pixel difference for all the pixels in the target MB (TMB) and a 16×16 area in the said search area in the previously transmitted frame, hereafter referred to as the search region candidate (SRC), is summed to arrive at the SAD value. If we assume that the upper right corner of search region candidate, SRC, is located at (i,j) location 304 in the previous frame as depicted in FIG. 3, the SAD is mathematically expressed by:

SAD=Σₙ₌₀^{n=N}·Σₘ₌₀^{m=M}|SRC(i+n,j+m)−TMB(n,m)|

where TMB denotes the target MB and assumed to be of dimension M×N. As an example, when we consider MB of size 16×16, the above equation may be written as:

SAD=Σₙ₌₀ⁿ⁼¹⁶·Σₘ₌₀^{m=16}|SRC(i+n,j+m)−TMB(n,m)|

In order to perform this calculation, we require M×N absolute difference calculations and M×N−1 additions. For a 16×16 block, this results in 256 absolute difference and 255 addition calculations for one SRC.

Note that this search might be conducted for every possible 16×16 area of the search area for previously transmitted frame which is the so-called the exhaustive search. In the example given above, there are 64×32=2048 different possible 16×16 matching search region candidates (SRC). This results in 2048×N×M absolute difference and 2048×(N×M−1) addition calculations. For a 16×16 block this results in 2048×256=524,288 absolute difference and 2048×255=522,240 addition calculations for entire search area of [−32,31]×[−16,15].

Similar calculations may be conducted for search regions of other sizes.

Those skilled in the art realize that this search regions are only examples of what a search region looks like and the system designer is free to choose values for both horizontal and vertical search regions.

The 16×16 search region candidate with the lowest value of SAD is then selected as the best match. The resulting reference pointers indicating the horizontal and vertical displacement (horizontal and vertical offset) of the best match with respect to the target MB, called the motion vectors (MV) are thus obtained. The MVs, therefore, indicate the matching position in the previously transmitted frame relative to the current position of the target MB.

There are also other means, such as the size of motion vectors, or measuring the required bit rate for transmission of MB and MVs, etc. which may be used as the criterion for selecting the best match.

The motion estimation (ME) contains the most intensive computational and the most memory requirements of the video compression system. It also consumes a large amount of energy or power for computation in the system.

Given the amount of computational requirements to perform a full-search motion estimation in which each and every SRC needs to be examined, there has been significant effort devoted to reducing the computational complexity.

The first class of methodology is concentrated in developing methods to reduce the number of points, or SRCs, that needs to be tested in the entire search region. Examples of these approaches are three-step method, logarithmic search method, or using the results of neighbor MBs to select the appropriate set of points to be tested.

A second class of methodology which complements the first, is to reduce the computational requirements for finding the SAD for a given SRC. In this method, the partial SAD is continuously or periodically compared to the SAD obtained for the best match so far, and the computation is stopped when the SAD exceeds that of the best match.

Our approach, discussed next, is close to the second class with significant difference. It can be easily incorporated in the first class of methodology.

### SUMMARY OF INVENTION

Accordingly, the present invention is directed to a method that substantially obviates one or more of the problems due to limitations, shortcomings, and disadvantages of the related art.

One advantage of the invention is greater efficiency in reducing the required computation in finding the best SRC in the search region for a given target MB (TMB).

Another advantage of the invention is the reduction of data cycles necessary to perform the search within the search region in order to obtain the best match.

A third advantage of the invention is that it allows slower and less expensive computational resources to accomplish the same task as the more expensive higher speed processors which need to be used for the systems not taking advantage of the current invention.

A fourth advantage of the invention allows bigger search regions to be used to find the best match for the same amount data cycles required by the systems not taking advantage of the current invention.

To achieve these and other advantages, one aspect of the invention includes a method of periodically comparing a calculated fraction of the total SAD for the current search area candidate, to a fraction of the same size or a fraction of larger size of best match currently available. Decision is then made to continue the SAD calculation for the current search region candidate or stop and proceed to the next search region candidate, if there is any search region candidate left. Note that the initial best match SAD, before any calculation is started, is set to a very larger number such as infinity.

There are no previous methods for reducing the computational complexity similar to the proposed system. The method of said second class is the closest to this approach and is significantly different from the said method.

### BRIEF DESCRIPTION OF DRAWINGS

The accompanying drawings illustrate a preferred embodiment of the invention. The drawings are incorporated in and constitute a part of this specification. In the drawings,

FIG. 1 is a block diagram of a video compression based on MPEG-1;

FIG. 2 is the search region [−32, 31]×[−16,15] in the previous frame and the target MB and examples of search candidate regions in the current frame;

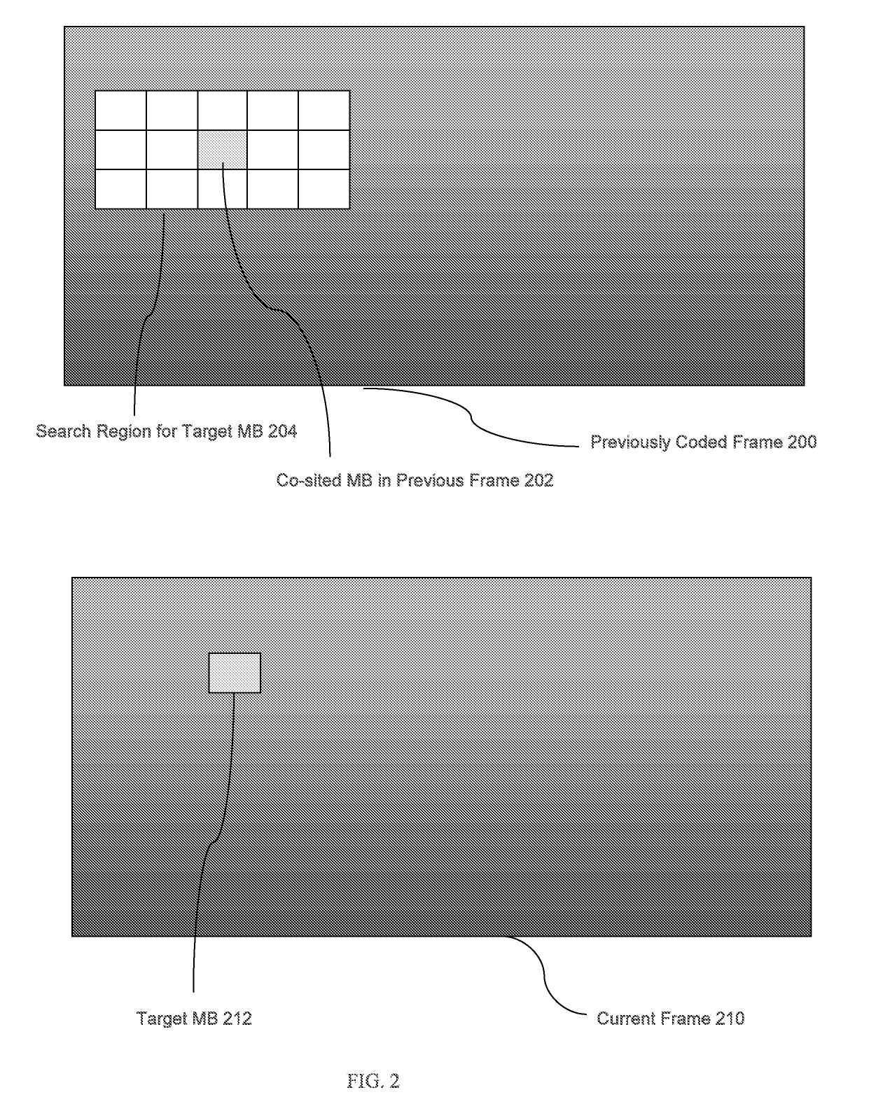

FIG. 3 is the pixels for search region [−32, 31]×[−16×15] in the previous frame for a target MB and illustrates the co-sited MB is the search region;

FIG. 4 is the illustration of a luminance of target MB.

### DETAILED DESCRIPTION

### Introduction

Methods consistent with the invention avoid the inefficiencies of the prior art for calculating the best match for a block or region in the motion estimation process by significantly reducing the amount of computation required to find the best match.

Following the procedure described in this invention, not only the power consumption for the system is reduced due to decrease in calculations, but also the cycle count for performing the best match calculation and therefore the cycle count for video compression is reduced since fewer cycles are required to find the best match.

Additionally, slower speed, and therefore, less expensive computational resources such as slower DSP or slower ASIC/SOC may be used to accomplish the same task that expensive, higher speed, computational resources achieve, when not using the current invention.

The method described here is applicable to all video coding standards such as MPEG-1, MPEG-2, MPEG-4, H.261, H.263, H.264, VC-1, VP8 in addition to any other video compression system employing motion estimation. This method is also applicable to any search mechanism that uses a template matching scheme.

To achieve the improvement in reduction of data movement, an implementation consistent with the invention provides a means for reducing the computational requirement by periodically comparing the distortion due to a fraction of the total number of samples between the target block and the search area candidate for decision making process. Since the distortion for only a fraction of samples is used, the computation requirements are reduced.

In the preferred implementation, the partial calculation is updated after the distortion for every row of MB is calculated, and then compared to same size or larger partial calculation due to the best match found so far.

In another method, the partial calculation is updated after the distortion for a pre-set number of pixels of MB is calculated, and then compared to same size or larger partial calculation due to the best match found so far. If it is decided to continue the calculations, the said computation and said comparsion is then conducted for larger and larger pre-set number of pixels and decision is made after each computation and comparison.

### Video Compression System

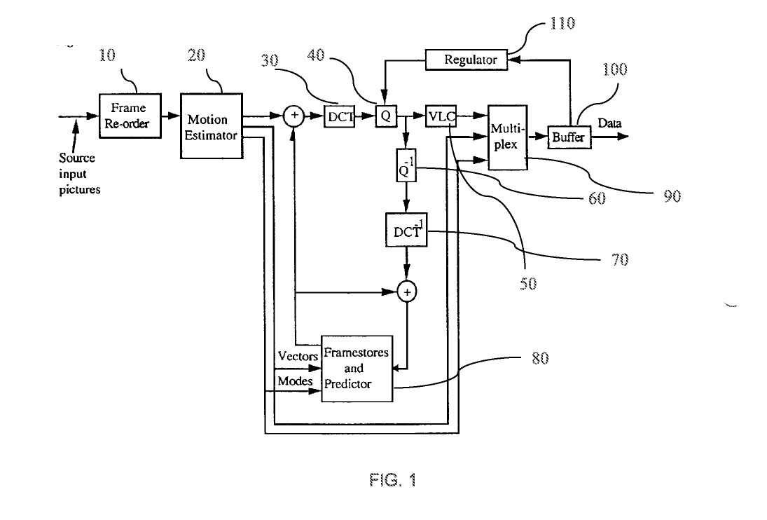

FIG. 1 illustrates a video compression system based on MPEG-1 developed by International Standards Organization (ISO) video coding standard. We chose MPEG-1 for illustration purposes since it is the first international standard in MPEG arena and all other ISO and International Telecommunication Union (ITU) video coding standards such as MPEG-2, MPEG-4, H.261, H.263, and H.264 follow the same principles as far as the motion estimation is concerned. System in FIG. 1 comprises of a frame reordering 10, a motion estimator 20, a discrete cosine transform (DCT) as block transform operator 30, a quantizer (Q) 40, a variable length encoder (VLC) 50, an inverse quantizer (Q⁻¹) 60, an inverse discrete cosine transform (DCT⁻¹) 70, a frame-store and predictor 80, a multiplexer 90, a buffer 100, and a regulator 110. The frame reordering component reorders the input video for proper coding order. The operation for each frame of video follows on MB by MB basis from left to right and starting from the top left hand corner of the frame and continues on, MB row by MB row basis, and ending at the bottom right hand corner of the frame. The motion estimator for P and B frames accesses the previously coded frames from the frame-store and provides the motion estimation for the MB. The motion estimator is not used for I frames. The output of the motion estimator which are used for P and B frames are motion vectors (MV), the selection mode indicates if motion estimation is used or not, and MB residuals which is the difference between the target MB and the chosen area in the previously transmitted frame, are now ready for compression. The said original or residual output for MB is then transformed using DCT, quantized using Q, variable length encoded using VLC, and is multiplexed with the MV data and selection modes and send to the buffer for storage or transmission. The buffer is used to regulate the output rate, as for example change the variable nature of video compression output to a fixed rate output which might be required for storage or transmission. The status of the buffer is then used by regulator to determine the value of quantizer (Q) to be used for subsequent MB data in order to sustain the required bit rate output of the system.

### Method of Operation

Systems consistent with the present invention replace the calculation of distortion or SAD between the target MB (TMB) and the search region candidate (SRC) for all the pixels in the MB by calculation of a subset of the total pixels in the MB.

More specifically, let us define a series of nested subsets of total pixels in the MB as follows:

frac1(SRC)⊂frac2(SRC)⊂ . . . ⊂fracN(SRC)=Total Pixels in MB,

where ⊂ indicates subset.

Here we calculate the distortion or SAD between the TMB and SRC for the first subset, namely, SAD(frac1(SRC)). We compare this value to SAD(fraci(best match)), where i≧1. We use the result of this comparison to decide if we want to continue with the SAD calculation for the rest of the samples in the MB.

If we decide to continue the calculation, we proceed with the calculation for the consecutive subsets and we perform the following comparison after calculating the SAD for each subset:

SAD(fraci(SRC))>SAD(fracj(best match))i≦j

and use the result to decide if we want to continue with the calculation of the SAD for the next subset.

Instead of starting at the very first subset to do the comparison, we can start the said comparison at the i'th subset for any value of i that we choose and also select the value of j for comparison as we choose with i≦j.

The idea behind the process is to compare the rate of change of SAD as we calculate the SAD for more pixels to the rate of change of SAD for the best match and decide if it is beneficial to continue with the rest of SAD calculations.

For example, if SAD(fraci(SRC))>SAD(fracj(best match)) for some i≦j, called exceed criterion, we might conclude that the SAD due to the calculation of total number pixels will be bigger also and therefore stop the computation for that SRC.

We might also consider that we need more than just one exceed criterion to hold true to decide to discontinue the calculation and therefore continue the calculations for more subsets.

### Illustration of Operation

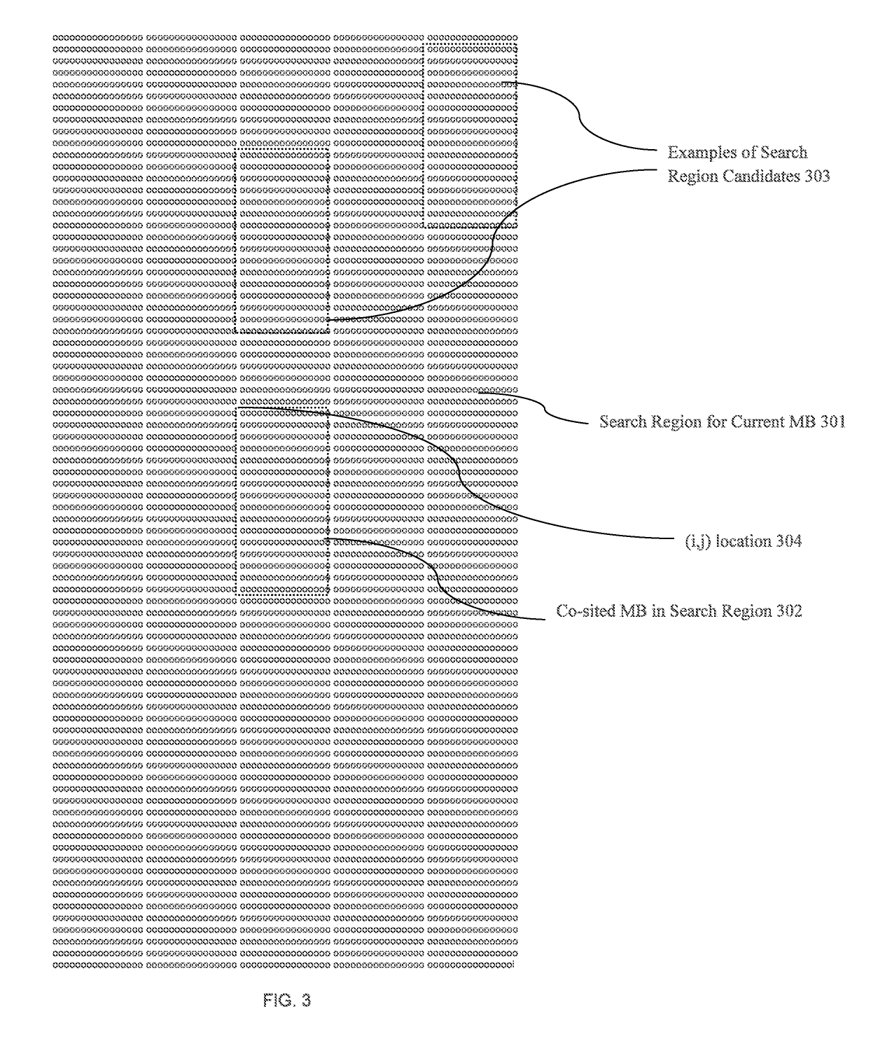

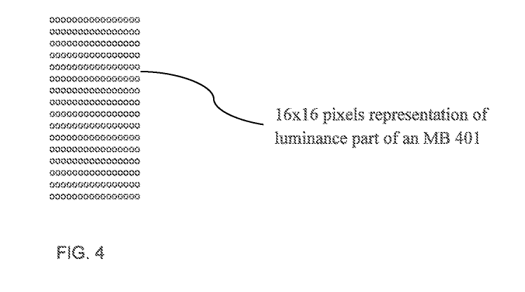

FIG. 3 illustrates a sample of search area 301 that might be used for search, examples of search region candidates 303, and co-sited MB 302. FIG. 4 illustrates a target MB (TMB). The motion estimation techniques finds the best match to the target MB within the search area. As can be observed from the search area, there are a total of 64×32=2048 candidate for the best match, referred to as search region candidates (SRC).

As described earlier, the SAD calculation for SRC with its top-right sample located at (i,j) 304, is represented by:

SAD=Σₙ₌₀ⁿ⁼¹⁶·Σₘ₌₀^{m=16}|SRC(i+n,j+m)−TMB(n,m)|

This calculation is conducted for each search area candidate.

As indicated before, we create a nested subset of pixels as follows:

frac1(SRC)⊂frac2(SRC)⊂ . . . ⊂fracN(SRC)=Total Pixels in MB.

In one example, we assume that the first subset consists of one row of pixels, the second subsets consists of two rows of pixels, and so on with the following subsets corresponding to increments of row of pixels. That is, frac1(SRC) is one row of pixels, farc2(SRC) is two rows of pixels, fracm(SRC) is m rows of pixels, and so on till the entire MB is covered.

For the process described in this invention, we calculate the SAD due to the first row of pixels, frac1(SRC), and compare the results to the SAD of one or more row of pixels of best match. We then decide to continue the process of calculation based on the outcome of the said comparison. For example, if the current SAD is bigger than the SAD due to the best match, we might decide to stop the calculation and continue to test the next search region candidate.

If we decide to continue, we can now compare to SAD for SRC due to two rows of samples, frac2(SRC), to the SAD of two rows or more of the best match. Again, similar to previous case, we can make a decision to continue the calculation or stop.

This process of comparison is conducted for each additional row of samples until either a decision to stop is reached or the SAD for total samples is calculated.

Note again, that we use a row of samples only as an example and alternative embodiments may be used for this purpose consisting of different number of samples and increments of samples for each subset.

### CONCLUSION

Systems consistent with the present invention provide for more efficient computation of distortion or SAD between a target MB and a search region candidate. These system provide more efficiency by comparing the distortion based only a fraction of total number of pixels in an MB and therefore reducing the cost of computation.

The above examples and illustrations of the advantages of using methods consistent with the present invention over the related art are not meant to limit application of the invention to cited examples. Indeed, as explained in the preceding sections, the methods consistent with present invention may use not only macroblocks but may also use multiple macroblocks, blocks or sub-blocks or objects in both motion estimation or pattern matching systems. Furthermore, the number of samples constituting each of the subsets are to be used only as examples and alternative embodiment may be used for this purpose.

What is claimed is:

1. A method for considering an area for the best match to the target block in motion estimation consisting of:
comparing the error calculated based on a fraction of the total pixels of the block, to the error calculated based on a different fraction of the total pixels of the block of the best match;
deciding if the current area is a worse match based on the said comparison.

2. A method for considering an area for the best match to the target block in motion estimation consisting of:
comparing the error calculated based on a fraction of the total pixel of the block to the error calculated based on the same fraction of the total pixels of the block of the best match;
deciding if the current area is a worse match based on the said comparison.

3. A method for considering an area for the best match to the target block in motion estimation consisting of:
comparing the error calculated based on a fraction of the total pixel of the block to the error calculated based on a larger fraction of the total pixels of the block, which includes the said fraction, from the best match;
deciding if the current area is a worse match based on this conducted comparison.

4. A method for reducing the computation in motion estimation for a target block in motion estimation comprising:
a) creating a nested sequence of patterns(i, j) (i=0, 1, 2, . . . , N−1) for the search region candidate (SRC), j;
b) initialization: setting i=0, j=0; calculating the distortion between the target block for all the patterns(i, 0), i=0, 1, 2, . . . , N−1; setting patterns(i, best)=patterns(i, 0), for all i's;
c) moving to next search area candidate, j=j+1;
d) setting i=0;
e) calculating the distortion, D, between the target block and the patterns(i,j) of the said nested patterns;
f) comparing the said result, D, to patterns(k,best) for k>=i;
g) deciding to continue or stop the calculation based on the result of said comparison in (f);
h) moving to the next pattern by increasing i by one (i=i+1);
i) if i=N exiting with SRC j as the best match;
j) otherwise going back to step (d).
k) if patterns(N−1,j)<patterns(N−1,best), setting patterns(i,best)=patterns(i,j) for all i's;
l) stopping if search area is exhausted;
m) otherwise going to step (h)

5. A method for reducing the computation in motion estimation for a target block comprising:
a) comparing the calculated distortion based on a fraction of total pixels in the block, D, for the search area candidate with an equal size or bigger fraction of best match;
b) deciding on continuing or stopping the calculation for the rest of pixels in the block based on the said comparison;
c) calculating the distortion for more pixels of the block, and going to step (a) if the distortion is not calculated for all the pixels in the block; otherwise;
d) comparing the total distortion due to search area candidate to the total distortion due to the best match; if distortion is bigger, continue to the next search area candidate; otherwise declare the said search area candidate as the best match;
e) if more search area candidate is still available, go to step (a) for the next search area candidate; otherwise declare the best match found.

6. A method for considering an area a better match to the target block in motion estimation consisting of:
comparing the error calculated based on a number of fractions of the total pixel of the block to the error calculated based on a number of fractions of the total pixels of the block from the best match;
deciding if the current area is a worse match based on the said conducted comparison.
